(19) United States
(12) Patent Application Publication
(10) Pub. No.: US 2018/0105140 A1
(43) Pub. Date: Apr. 19, 2018

(54) WINDSHIELD WIPER SYSTEM FOR MINIMIZING ICE BUILDUP AND FREEZING OF WINDSHIELD WIPERS

(71) Applicant: FORD GLOBAL TECHNOLOGIES, LLC, Dearborn, MI (US)

(72) Inventors: Aed M. Dudar, Canton, MI (US); Mahmoud Yousef Ghannam, Canton, MI (US)

(21) Appl. No.: 15/296,785

(22) Filed: Oct. 18, 2016

(51) Int. Cl. B60S 1/08; B60S 1/02; B60S 1/16

(52) U.S. Cl. CPC B60S 1/0866; B60S 1/0844; B60S 1/163; B60S 1/026

(57) ABSTRACT

A motor vehicle windshield wiper system includes a windshield wiper and a controller. The controller is configured, in response to a threat of freezing precipitation, to park the windshield wiper in a parked position with a first end of the windshield wiper oriented toward a top edge of the windshield and a second end of the windshield wiper oriented toward a bottom edge of the windshield. A related method of minimizing ice and snow buildup on a windshield wiper is also disclosed.

### TECHNICAL FIELD

This document relates generally to the motor vehicle equipment field and, more particularly, to a windshield wiper system and related method for minimizing buildup of frozen precipitation on the windshield wipers of a motor vehicle.

### BACKGROUND

It is well known in the art to equip motor vehicles with windshield wipers that sweep across the windshield in order to clear precipitation and road film and provide a better view for the safe operation of the motor vehicle. When not in use, windshield wipers are typically moved to a rest position where they extend along the bottom edge of the windshield in a substantially horizontal orientation. There the windshield wipers effectively form a shelf that promotes the buildup of freezing precipitation on the windshield wipers during inclement winter weather.

This document relates to a new and improved windshield wiper system and related method that minimizes the buildup of frozen precipitation on the windshield wipers thereby enhancing their proper operation and effectively increasing the service life of the rubber blades of the windshield wiper which may be degraded when they are frozen to the surface of the windshield and must be forcibly released.

### SUMMARY

In accordance with the purposes and benefits described herein, a windshield wiper system is provided for the windshield of a motor vehicle. That windshield wiper system comprises a windshield wiper and a controller configured, in response to a threat of freezing precipitation, to park the windshield wiper in a parked position with a first end of the windshield wiper oriented toward a top edge of the windshield and a second end of the windshield wiper oriented toward a bottom edge of the windshield. For purposes of this document, the phrase “threat of freezing precipitation” means conditions exist for the potential or actual accumulation of freezing precipitation at the location of the motor vehicle within a given timeframe of predetermined length.

The windshield wiper system may further include a motor for driving the windshield wiper. That motor is controlled by the controller. Further, the windshield wiper system may include a freezing precipitation data device connected to the controller. That freezing precipitation data device may be selected from a group of devices consisting of a temperature sensor, a precipitation sensor, a humidity sensor, a camera, a global positioning satellite (GPS) device, a weather forecast data device and combinations thereof.

The windshield wiper system may further include a heating element in the windshield adjacent the windshield wiper when the windshield wiper is in the parked position. That heating element may be controlled by the controller. In at least one of the many possible embodiments, the parked position of the windshield wiper is located adjacent an A-pillar of the motor vehicle at one end of the windshield.

The controller may be configured to include a first data input for ambient temperature data. The controller may also be configured to include a second data input for precipitation data. In addition, the controller may be configured to include a third data input for ambient humidity data. Still further, the controller may be configured to include a data input for a camera image. In addition, the controller may be configured to include a data input for GPS data.

In accordance with an additional aspect, a method is provided of minimizing ice and snow buildup on a windshield wiper of a motor vehicle. That method comprises the steps of: determining, by a monitoring device, existence of an actual threat of freezing precipitation; and parking, by controller, a windshield wiper in a parked position with a first end of the windshield wiper oriented toward a top edge of the windshield and a second end of the windshield wiper oriented toward a bottom edge of the windshield.

In addition, the method may include the step of monitoring, by a first monitoring device ambient temperature. Further, the method may include the step of monitoring, by a second monitoring device falling precipitation. Still further, the method may include the step of monitoring, by a third monitoring device, ambient humidity. Still further, the method may include the step of monitoring, but a fourth monitoring device a weather forecast.

Still further, the method may include monitoring, by a GPS device, a current location of the motor vehicle. Further, the method may include providing a heating element in the windshield at the parked position for warming the windshield and the parked windshield wiper to reduce or eliminate frozen precipitation.

In the following description, there are shown and described several preferred embodiments of the windshield wiper system as well as the related method for minimizing ice and snow buildup on a windshield of a motor vehicle wiper. As it should be realized, the windshield wiper system and related method are capable of other, different embodiments and their several details are capable of modification in various, obvious aspects all without departing from the windshield wiper system and method as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the windshield wiper system and together with the description serve to explain certain principles thereof.

FIG. 1 is a schematic block diagram of the windshield wiper system.

FIG. 2 is a schematic illustration of a windshield in a tandem windshield wiper system.

FIG. 3 is a schematic illustration of a windshield in an opposed dual windshield wiper system.

FIG. 4 is a schematic illustration of a windshield and a single arm windshield wiper system.

FIG. 5 is a schematic illustration of one possible embodiment of the windshield wiper system incorporating opposed dual windshield wipers that are illustrated in a parked position adjacent the A-pillars of the motor vehicle at the ends of the windshield wherein the windshield incorporates heating elements at the parked position.

FIG. 6 is a control logic flow diagram of one possible embodiment of the windshield wiper system.

Reference will now be made in detail to the present preferred embodiments of the windshield wiper system, examples of which are illustrated in the accompanying drawing figures.

### DETAILED DESCRIPTION

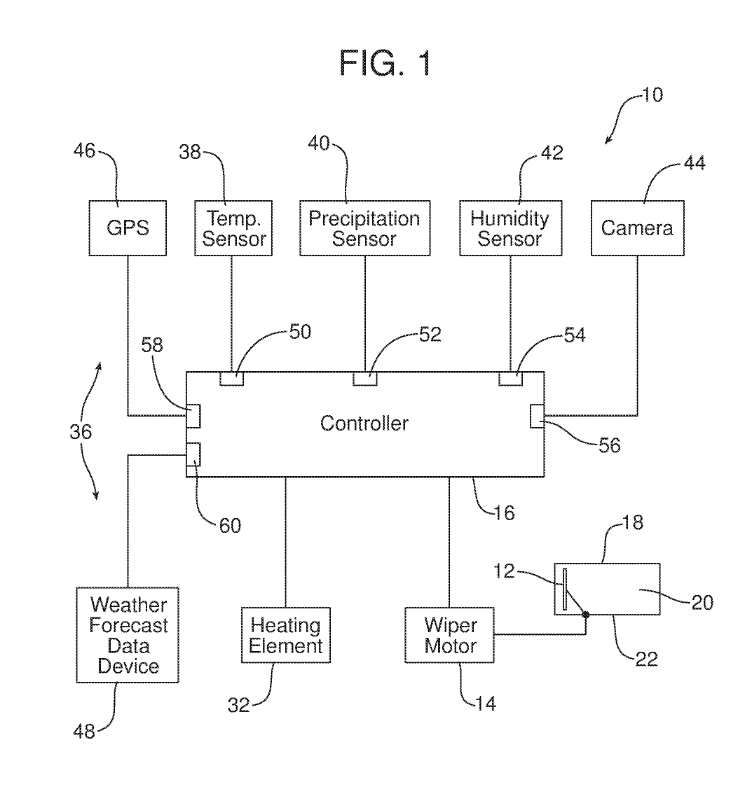

Reference is now made to FIG. 1 which is a schematic block diagram illustrating one possible embodiment of the windshield wiper system 10. That system 10 includes at least one windshield wiper 12 driven by a wiper motor 14. The windshield wiper system 10 also includes a controller 16. The controller 16 may be a computing device such as a dedicated microprocessor or electronic control unit (ECU) operating in accordance with instructions from appropriate control software. Such a controller 16 may comprise one or more processors, one or more memories and one or more network interfaces all in communication with each other over a communication bus.

The controller 16 is configured, in response to a threat of freezing precipitation, to park the windshield wiper 12 in a parked position with a first end of the windshield wiper oriented toward a top edge 18 of the windshield 20 and a second end oriented toward a bottom edge 22 of the windshield.

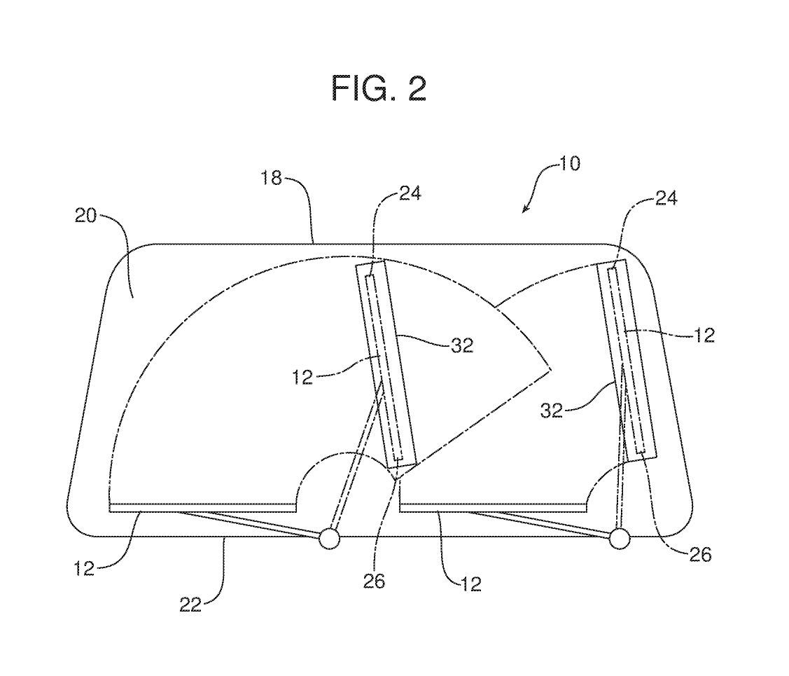

FIG. 2 illustrates one possible embodiment of a windshield wiper system 10 incorporating tandem windshield wipers 12. When the windshield wipers are in the normal off position, they are oriented along the bottom edge 22 of the windshield 20 in a rest position as illustrated in full line in FIG. 2. However, when there is a threat of freezing precipitation, the controller 16 parks the windshield wipers 12 as illustrated in phantom line with the first end 24 of the windshield wipers 12 oriented toward the top edge 18 of the windshield 20 and the second end 26 of the wipers oriented toward the bottom edge 22 of the windshield. In this parked position, the windshield wipers 12 are oriented substantially in a alignment with the Z axis of the motor vehicle so that any freezing precipitation is shed down the length of the windshield wipers thereby avoiding buildup of freezing precipitation such as sleet, ice, snow and freezing rain. In contrast, if the windshield wipers 14 were positioned substantially horizontally across the bottom edge 22 of the windshield in the normal or rest position, the wipers would function as a shelf holding the freezing precipitation and tending to promote its buildup on the wipers.

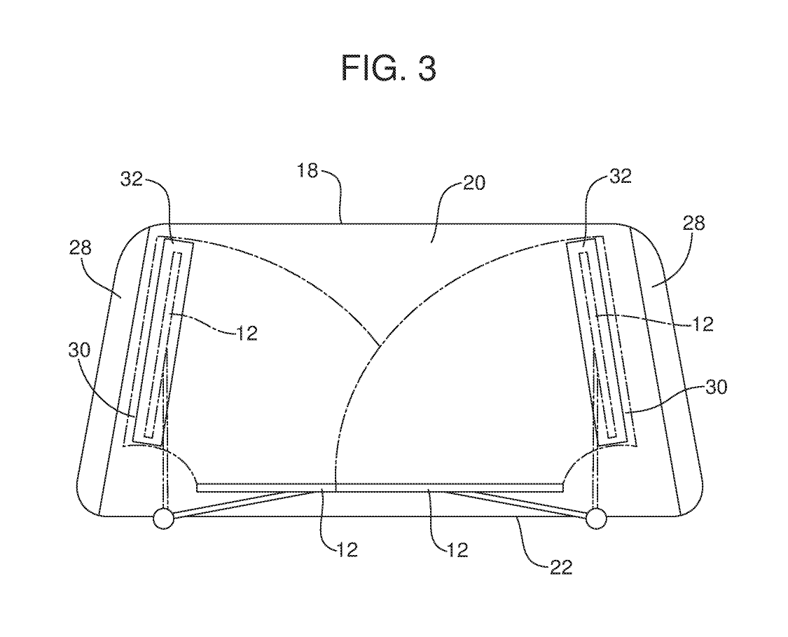

FIG. 3 illustrates an alternative embodiment of windshield wiper system 10 incorporating opposed dual wipers 12. During normal wiper operation those opposed windshield wipers 12 are stowed along the bottom edge 22 of the windshield 20 in a rest position as illustrated in full line. However, in response to a threat of freezing precipitation, the controller 16 is configured to park those windshield wipers in the substantially vertically oriented parked position illustrated in phantom line along the A-pillars 28 at the opposite ends 30 of the windshield 20. As illustrated in the various drawing figures, the windshield wiper system 10 may further include a heating element 32 within the windshield 20 at each of the parked positions. Those heating elements 32 are operated under the control of the controller 16 and function to heat the windshield 20 and the windshield wipers 12 at the parked position, and thereby prevent freezing and sticking of the windshield wipers to the windshield even under the most severe inclement winter weather conditions.

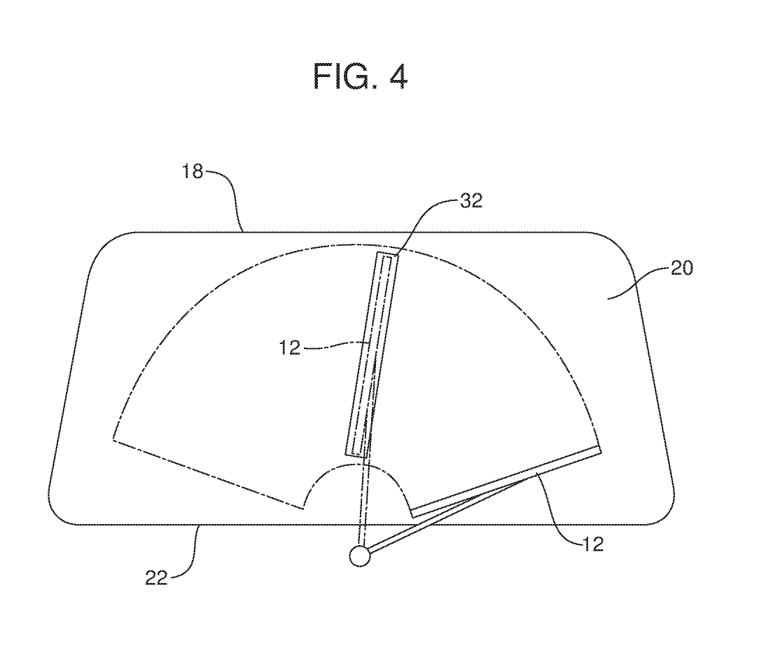

FIG. 4 illustrates yet another embodiment of the windshield wiper system 10 incorporating a single windshield wiper 12. That windshield wiper 12 is normally stowed adjacent the bottom corner 34 of the windshield 20 in the rest position. However, in response to a threat of freezing precipitation, the controller 16 is configured to park the windshield wiper 12 in the parked position illustrated in phantom line in FIG. 4 wherein the windshield wiper has a first end 24 oriented toward the top edge 18 of the windshield 20 and a second end 26 oriented toward a bottom edge 22 of the windshield. Thus, as with the other embodiments, the windshield wiper is oriented substantially vertically along the Z axis of the motor vehicle so that freezing precipitation is shed downwardly along the length of the windshield wiper rather than collecting on top of the windshield wiper.

As further illustrated in FIG. 1, the windshield wiper system may include one or more freezing precipitation data devices 36 connected to the controller 16. The freezing precipitation devices may be selected from a group of devices consisting of a temperature sensor 38, a precipitation sensor 40, a humidity sensor 42, an image capturing camera 44, a GPS device 46 and a weather forecast data device 48.

In the illustrated embodiment, the controller 16 is configured to include a first data input 50 connected to the temperature sensor 38 and adapted to receive ambient temperature data. Further, the controller 16 is configured to include a second data input 52 connected to the precipitation sensor 40 and adapted to receive precipitation data. In addition, the controller 16 is configured to include a third data input 54 connected to the humidity sensor 42 and adapted to receive ambient humidity data.

Still further, the controller 16 is configured to include a fourth data input 56 that is connected to the imaging camera 44 and adapted to receive images of the windshield 20 indicating the presence of freezing precipitation. Further, the controller 16 is configured to include a fifth data input 58 connected to the GPS device and adapted to receive GPS data indicating the current location of the motor vehicle to which the windshield wiper system 10 is connected. Still further, the controller 16 is configured to include a sixth data input 60 connected to the weather forecast data device 48 and adapted to receive weather forecast data indicating expected weather at the GPS indicated location for the motor vehicle. The weather data may also include intelligent V2X weather data.

Consistent with the above description, a method is provided for minimizing ice and snow buildup on a windshield wiper 12 of a motor vehicle. That method comprises the steps of: (a) determining, by a monitoring device such as a freezing precipitation device 36, the existence of an actual threat of freezing precipitation and (b) parking, by the controller 16, a windshield wiper 12 in a parked position with a first end 24 oriented toward a top edge 18 of the windshield 20 and a second end 26 oriented toward a bottom edge 22 of the windshield. As previously noted, a threat of precipitation means that meteorologic conditions exist for the potential or actual accumulation of freezing precipitation at the location of the motor vehicle within a given timeframe such as, for example, the next 72 hours, next 48 hours, the next 36 hours, the next 30 hours, the next 24 hours, the next 20 hours, the next 18 hours, the next 15 hours, the next 12 hours, the next 10 hours, the next 9 hours, the next 8 hours, the next 7 hours, the next 6 hours, the next 5 hours, the next 4 hours, the next 3 hours, the next 2 hours, the next 1 hour, the next 30 minutes, the next 10 minutes, the next 5 minutes.

The method may include the step of monitoring, by means of a first monitoring device or temperature sensor 38 the ambient temperature. Further, the method may include the step of monitoring, by a second monitoring device or precipitation sensor 40 falling precipitation.

Further, the method may include monitoring, by a third monitoring device or humidity sensor 42 the ambient humidity. Still further, the method may include monitoring, by a fourth monitoring device or weather forecast data device 48 a weather forecast. Further, the method may include monitoring, by a GPS device 46 the location of the motor vehicle.

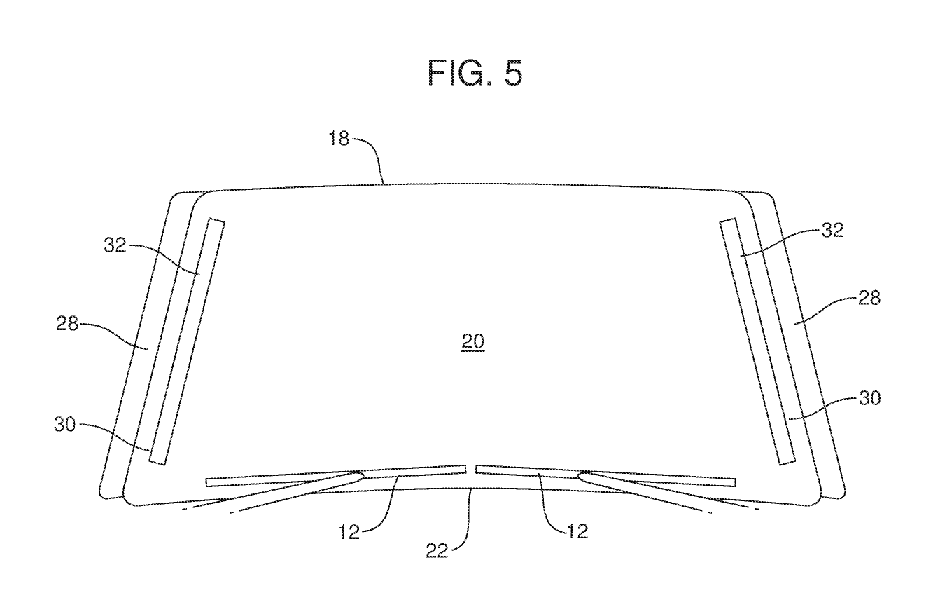

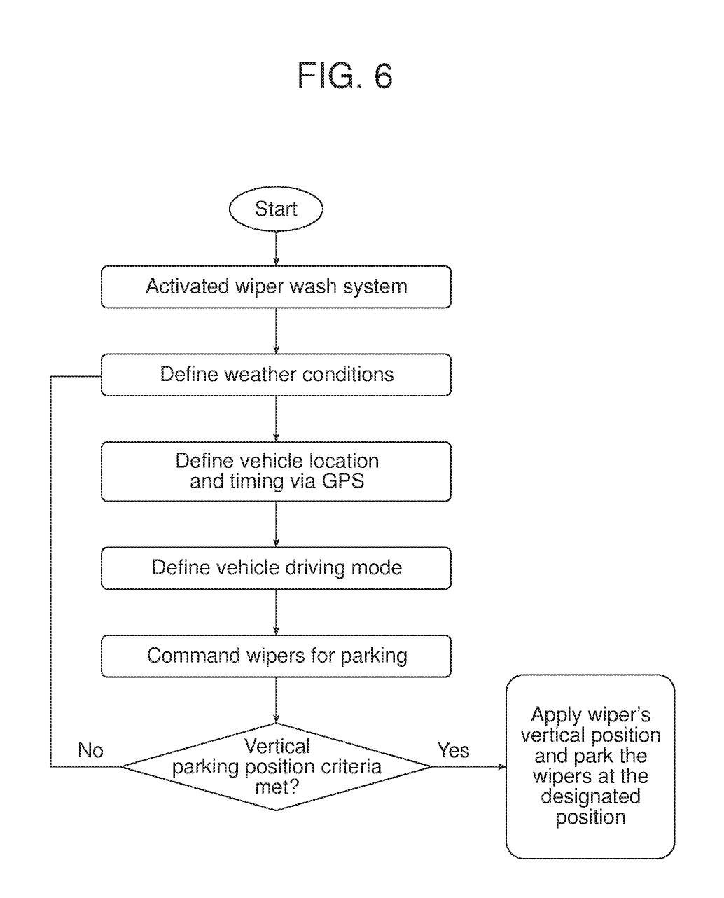

In addition, the method may include the step of providing a heating element 32 in the windshield 20 at the parked position of the windshield wiper 12. Such is illustrated in FIG. 5. This heating device on element 32 functions to heat the windshield 20 and the windshield wiper 12 so as to prevent the windshield wiper from freezing and sticking to the windshield even under the severest inclement winter weather conditions. FIG. 6 is a self-explanatory control logic flow diagram of one possible embodiment of the windshield wiper system 10.

The foregoing has been presented for purposes of illustration and description. It is not intended to be exhaustive or to limit the embodiments to the precise form disclosed. Obvious modifications and variations are possible in light of the above teachings. For example, while not previously noted, the operation of the motor vehicle may manually park the windshield wipers 12 in the parked position with the ends 24, 26 oriented toward the top and bottom edges 18, 22 of the windshield 20 if desired. This may be done, for example, by depressing a control button or touch screen button connected to the controller or, for example, by voice command. All such modifications and variations are within the scope of the appended claims when interpreted in accordance with the breadth to which they are fairly, legally and equitably entitled.

What is claimed:

1. A windshield wiper system for a windshield of a motor vehicle, comprising:
a windshield wiper; and
a controller configured, in response to a threat of freezing precipitation, to move said windshield wiper into a parked position with a first end oriented toward a top edge of said windshield and a second end oriented toward a bottom edge of said windshield.

2. The windshield wiper system of claim 1, further including a motor for driving said windshield wiper, said motor being controlled by said controller.

3. The windshield wiper system of claim 2, further including a freezing precipitation data device connected to said controller.

4. The windshield wiper system of claim 3, wherein said freezing precipitation data device is selected from a group of devices consisting of a temperature sensor, a precipitation sensor, a humidity sensor, a camera, a GPS device, a weather forecast data device and combinations thereof.

5. The windshield wiper system of claim 4, further including a heating element in said windshield adjacent said windshield wiper when said windshield wiper is in said parked position.

6. The windshield wiper system of claim 5, wherein said heating element is controlled by said controller.

7. The windshield wiper system of claim 6, wherein said parked position of said windshield wiper is located adjacent an A-pillar of said motor vehicle at one end of said windshield.

8. The windshield wiper system of claim 1, wherein said controller is configured to include a first data input for ambient temperature data.

9. The windshield wiper system of claim 8, wherein said controller is configured to include a second data input for precipitation data.

10. The windshield wiper system of claim 9, wherein said controller is configured to include a third data input for ambient humidity data.

11. The windshield wiper system of claim 1, wherein said controller is configured to include a data input for a camera image.

12. The windshield wiper system of claim 1, wherein said controller is configured to include a data input for GPS data.

13. A method for minimizing ice and snow buildup on a windshield wiper of a motor vehicle, comprising:
determining, by monitoring device, existence of an actual threat of freezing precipitation; and
parking, by controller, said windshield wiper in a parked position with a first end of said windshield wiper oriented toward a top edge of a windshield and a second end of said windshield wiper oriented toward a bottom edge of said windshield.

14. The method of claim 13, further including monitoring, by a first monitoring device, ambient temperature.

15. The method of claim 14, further including monitoring, by a second monitoring device, falling precipitation.

16. The method of claim 15, further including monitoring, by a third monitoring device, ambient humidity.

17. The method of claim 16, further including monitoring, by a fourth monitoring device, a weather forecast.

18. The method of claim 17, further including monitoring, by a GPS device, a location of said motor vehicle.

19. The method of claim 18, further including providing a heating element in said windshield at said parked position.

20. The method of claim 13, further including providing a heating element in said windshield at said parked position.
